(19) United States
(12) Patent Application Publication
(10) Pub. No.: US 2025/0051092 A1
(43) Pub. Date: Feb. 13, 2025

(54) SYSTEM AND METHOD FOR IDENTIFYING, SORTING, AND MONITORING DISCARDED OBJECTS

(71) Applicants: John Jennings Calhoun Starke, Raleigh, NC (US); John William Starke, Leesburg, VA (US)

(72) Inventors: John Jennings Calhoun Starke, Raleigh, NC (US); John William Starke, Leesburg, VA (US)

(21) Appl. No.: 18/448,876

(22) Filed: Aug. 11, 2023

(51) Int. Cl. B65F 1/14; B65F 1/00

(52) U.S. Cl. CPC B65F 1/1484; B65F 1/006; B65F 2001/008; B65F 2210/1123; B65F 2210/12; B65F 2210/138; B65F 2210/139; B65F 2210/1443; B65F 2210/152; B65F 2210/168; B65F 2210/172; B65F 2210/176

(57) ABSTRACT

This disclosure provides methods, devices, and systems that may include a container housing having at least one opening, as well as a camera configured to capture a visual input relating to a deposited object placed into the at least one opening. A light source may be configured to illuminate the deposited object, and a sorting plate configured to divert the deposited object into one of a plurality of containers. A motor may be configured to move the sorting plate, and a processor system configured to: receive the visual input from the camera, classify the deposited object based on the visual input, and cause the motor to move the sorting place to divert the deposited object to the one of the plurality of containers based on the classification.

### BACKGROUND

### 1. Field of Disclosure

The present disclosure relates generally to waste management, and particularly to waste collection receptacles.

### 2. Description of Related Art

Waste stream management may coordinate waste from its inception to its final disposal or reuse. Associated processes seek to ensure that the handling of the items flowing through the waste stream happens efficiently and responsibly. Incorrect handling, storage, and disposal may cause environmental damage or harm to people (e.g., where recycling occurs). Improper management may ruin recyclable goods and make workers within the industry less safe. Conversely, effective waste stream management may realize income streams, yielding economic value.

### SUMMARY

The systems, methods, and devices of this disclosure each have several innovative aspects, no single one of which is solely responsible for the desirable attributes disclosed herein.

One innovative aspect of the subject matter described in this disclosure may be implemented as system that includes a container housing having at least one opening, as well as a camera configured to capture a visual input relating to a deposited object placed into the at least one opening. A light source may be configured to illuminate the deposited object, and a sorting plate configured to divert the deposited object into one of a plurality of containers. A motor may be configured to move the sorting plate, and a processor system configured to: receive the visual input from the camera, classify the deposited object based on the visual input, and cause the motor to move the sorting place to divert the deposited object to the one of the plurality of containers based on the classification.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

FIG. 1 is an external view of the waste sorting and analysis apparatus in a perspective view.

FIG. 2 is a block diagram illustrating examples of components of a waste sorting and analysis system that may, in some respects, eliminate recycling contamination and divert materials from landfills.

FIG. 3 is a perspective view of a discarded item container that includes multiple openings for different types of items, as well as a panel to communicate data pertinent to the operation of the container (e.g., fullness, charge, or estimated fullness, another other data) according to various embodiments.

FIG. 4 is a perspective view of a container without an exterior cover to show internal components that include a processing module, an identification module, a compression module, a tilt sort platform, and waste bins.

FIG. 5 is a view of the system identification of a trash object placed within the waste sorting and analysis system.

FIG. 6 is a view of the system identification of an object that may be recycled placed within the waste sorting and analysis system.

FIG. 7 is a view of an error message on the analysis panel of the waste sorting and analysis apparatus.

FIG. 8 is a system that includes multiple electronic display devices configured to relate waste stream and container information to a user.

FIG. 9 is a flowchart having illustrative processes consistent with an implementation.

### DETAILED DESCRIPTION

The following description is directed to certain implementations for the purposes of describing innovative aspects of this disclosure. However, a person having ordinary skill in the art will readily recognize that the teachings herein may be applied in a multitude of different ways.

An implementation comprises a smart waste container that automatically sorts public municipal waste into trash (e.g., waste for a landfill) and one or more types of recyclable material. In certain implementations, the system may identify all types of trash, including identifying (e.g., by bar code, shape, odor, brand, and material composition, among other detectable data) aspects of the discarded items, whether they are bound for a landfill or recycling facility. A system may increase diversion of recyclable material from landfills to reprocessing and to decrease contamination of recyclable materials. The system may collect and report data on the container operation and detailed waste stream components to the owners.

The apparatus is highly customizable. This may include modular components that may be set up in a factory or exchanged in the field. An example of such customization may include designs, or notices on original equipment manufacturer (OEM) and replacement siding materials. According to a particular aspect, the system may be suited for indoor or outdoor operation, including both plug in and solar power.

The waste bins of an embodiment may be symmetrical or asymmetrical, customized to an expected need of a user. The expected need of a user may be ascertained over time by collecting and analyzing at the customer site, or estimating the need based on models exhibiting similar environmental circumstances. A total number of bins may be added or taken away in the field based on changing user requirements.

An implementation may include a display panel on the apparatus. The display panel may visually communicate any other user data described herein (e.g., communicated over the Internet), but additionally is readily visually accessible to custodial or other user at the site. For instance, a user may be able to see on the panel how full one or more particular bins might be, or to indicate that the user has mistakenly identified an object placed within the apparatus and that corrective action has been taken. The panel may also describe a prediction in hours of how long space may be available before the bin(s) need to be emptied. Other features may include bin compaction and mechanisms for clearing an obstruction. An illustrative display may show a percentage of recycling capacity that is full, and may convey the same information for trash container(s). Other displayed information may include a total number of deposits (e.g., for a day or since unit installation), and a number of items diverted from a landfill as a result of the unit.

A particular aspect of the display panel may include multiple openings in the container. The display (which may comprise or otherwise be linked to a speaker) may visually or audibly present educational concepts to the person who discarded the object. For instance, the display may present educational information about landfills in response to the user discarding an object into a first opening, labeled, “non-recyclable.” The user depositing an object in a second opening, labeled, “plastics,” may be visually presented with statistics regarding how recycling can reduce carbon emissions.

In operation, a person may discard an item that falls or is otherwise positioned into proximity of an identification module. The identification module may identify the type of waste material using one or more types of sensors and determine if the material is recyclable. The image of each waste item may be retained for later data analysis. For example, the data may be used in statistical outputs for municipalities, or may be included in a library database accessed by machine learning to be iteratively taught more effective identification. In another example, if the material is recyclable, the identification function may classify the waste item by type, including, but not limited to, metal, plastic, glass, paper or compost. Identification may be accomplished by exposing waste material to one or more sensors. For example, a camera may be used to detect visual input, not limited to visible light, near infrared, infrared, and ultraviolet radiation. The sensors produce data on the waste item that is used to characterize the material in the waste item.

The waste identification feature may capture data as input to a machine learning system. The system may use machine learning compare the waste item data to known types of trash and recyclable material. In one implementation, the system may prepare a probability estimate the type of material. If the waste item type estimate meets the threshold for a type of material decision, the automatic sorting system is instructed to send the waste item to the appropriate waste bin. If the waste item type estimate does not meet the type identification threshold, the default decision is for trash. The estimated threshold for certain types of discarded objects may be programmable for the recycling needs of owners. The thresholds may be preset according to different recycling objectives and constraints from laws or regulations for recycling.

Discarded items may be sorted by one or more sorting plates that move the waste item to the appropriate bin, which may be a bin for trash or one or more types of recyclable material. Implementations may accommodate binary waste sorting for trash or recyclable material, as well as for 3-way and 4-way sorting, etc. The sorting plate(s) may be driven by one or more actuators instructed by the system. An implementation may use stepper motors and gearboxes to rotate a sort plate.

Where configured as such, the plates may be coordinated and layered with regard to each other in a cascading fashion (e.g., each plate dividing into a more specific category). For instance, a first layer plate may separate organic matter from a plastic. A second layer plate may separate the plastic into different bins according to a recyclable potential of the sorted plastic items.

As described herein, a clog may be addressed by moving the plates to dislodge it. A user may program the number of attempt to move the waste item. If clog condition continues, the user will be notified. The sorting plates may divert discarded items away from a full bin to one that has capacity.

A power management system may prevent damage to electrical systems by filtering electrical voltage or current spikes. Solar options are protected with power management controls that allocate power to critical functions when solar collectors do not have sufficient energy to recharge batteries. Solar panels may allow the system to be set up in areas where accessibility issues render plugin power solutions impractical.

Alarms and other reporting may be communicated to users via wireless connections, speakers, and the display on the discarded object receiving device. Implementations may eliminate recycling contamination and divert materials from landfills. The system may provide collect waste stream data from the source in real time, as well as reduce the frequency and cost of waste collection. The system may connect through Wi-Fi or 4G/LTE to identify and export waste stream information. Users are automatically informed as to exactly when each bin needs to be emptied from any specific location. The system additionally identifies and sorts discarded waste into trash and recycling.

Brief definitions of terms, abbreviations, and phrases used throughout this document are given below. Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements. The coupling or connection between the elements may be physical, logical, or a combination thereof. For example, two devices may be coupled directly, or via one or more intermediary channels or devices. As another example, devices may be coupled in such a way that information may be passed therebetween, while not sharing any physical connection with one another.

Additionally, the words “herein,” “above,” “below,” and words of similar import, when used in this document, shall refer to this document as a whole and not to any particular portions of this application. Where the context permits, words in this specification using the singular or plural number may also include the plural or singular number respectively. The word “or,” in reference to a list of two or more items, covers all of the following interpretations of the word: any of the items in the list, all of the items in the list, and any combination of the items in the list,

If the specification states a component or feature “may,” “can,” “could,” or “might” be included or have a characteristic, that particular component or feature is not required to be included or have the characteristic. In this document, the terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

In this document, the terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

The terminology used in this specification is intended to be interpreted in its broadest reasonable manner, even though it is being used in conjunction with certain examples. The terms used in this specification generally have their ordinary meanings in the art, within the context of the disclosure, and in the specific context where each term is used.

For convenience, certain terms may be highlighted, for example, using capitalization, italics, and/or quotation marks. The use of highlighting has no influence on the scope and meaning of a term; the scope and meaning of a term is the same, in the same context, whether or not it is highlighted. It will be appreciated that the same element may be described in more than one way.

Consequently, alternative language and synonyms may be used for any one or more of the terms discussed herein, but special significance is not to be placed upon whether or not a term is elaborated or discussed herein. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

The technology presented here includes systems and methods to automatically determine the type of waste deposited into a waste container. The system may additionally dispense the waste into an appropriate waste bin, such as a recyclable waste bin, a non-recyclable (i.e., landfill or compost) waste bin, and/or further categories and subcategories of waste (such as recyclable paper or recyclable plastics) without the need for the user to decipher complicated pictures, or read lengthy instructions, before throwing a piece of waste away.

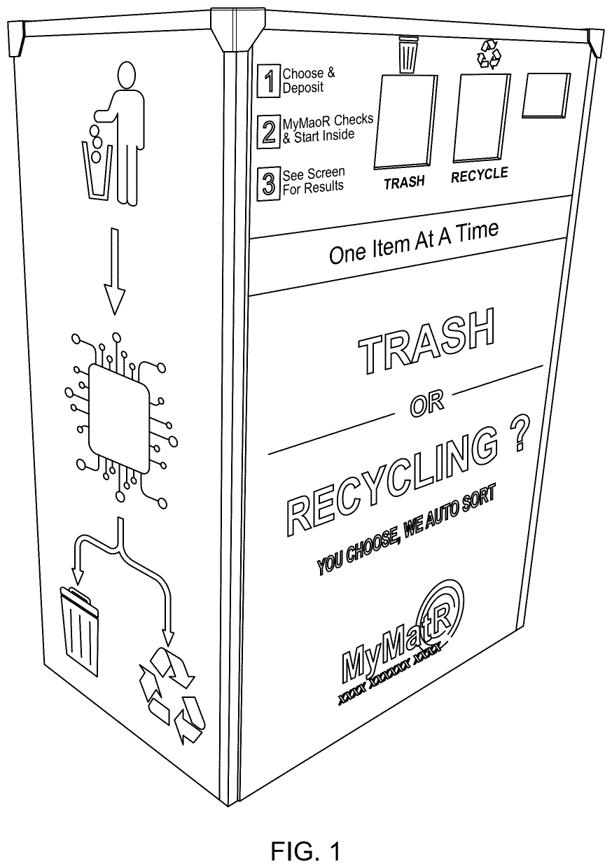

FIG. 1 is an external view of the waste sorting and analysis apparatus as it may appear when placed within a facility for use by the occupants of the facility.

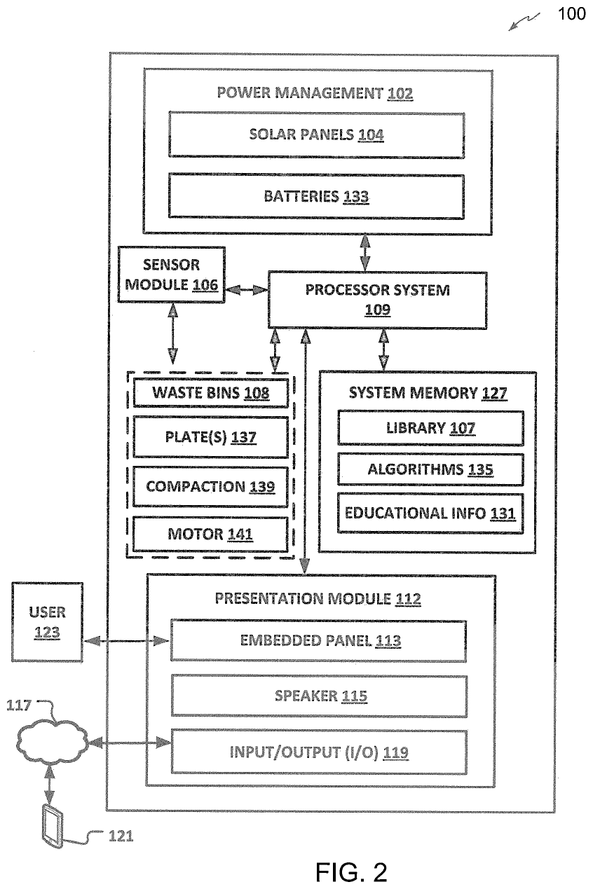

FIG. 2 is a block diagram illustrating examples of components of a waste sorting and analysis system that may, in some respects, eliminate recycling contamination and divert materials from landfills. The system 100 may provide a waste stream data from sources in real time, as well as reduce the frequency and cost of waste collection. The system 100 may connect through wireless technologies to identify and export waste data. Users may be automatically informed as to exactly when each bin needs to be emptied from any specific location. The system 100 additionally identifies and sorts discarded waste into trash and recycling.

As shown in FIG. 2, the system includes a power management system 102 that may provide power to the system 100, as well as prevent damage to electrical systems by filtering electrical voltage or current spikes. The power management system 102 may include wiring to an electrical grid and/or batteries. A solar panel 104 of the power management system 102 may allow the system 100 to be set up in areas where accessibility issues render plugin power solutions impractical, although the system may also be powered through a plug-in power source. The term “power management” may refer to any power source, where the power source provides sufficient energy to operate the system 100. Although the power source is reliable, there may be a power monitoring capability to monitor and maintain the reliability of the power source.

A sensor module 106 may use various sensors to automatically determine a type of a discarded item, and dispense the item into appropriate waste bins 108. Examples of such bins 108 may include a recyclable waste bin and a landfill waste bin. In a particular example, the system 100 may determine that discarded material is recyclable. For example, the system 100 may identify form a bar code, weight, and shape, that a discarded item is a particular brand of bottle. They system may classify the discarded items and sort them accordingly.

In addition to the various types of sensors used in classifying and/or identifying the various pieces of waste inserted into the waste container, one or more additional sensors may be present within the system 100 so as to determine the fullness and/or remaining capacity of one or more of the waste bins 108 therein. For example, one or more sonar sensors or infrared sensors of the sensor module 106 may be utilized within the waste container to determine the relative fullness and/or remaining capacity of one or more of the bins 108.

The waste container system 100 may have a presentation module 112, display, or some external indicator, such as a visual and/or audible indicator. As depicted in FIG. 2, the module 112 includes an embedded panel 113 and a speaker 115. A I/O module 119 may communicate with the Internet 117 or other wireless hub to communicate with remote devices 121 of a user 123. The presentation module 112 may notify a responsible party that a particular waste bin 108 is at or near capacity and should therefore be emptied. For example, one or more light-emitting diodes or other visual indicators viewable directly at the waste container may be illuminated when a waste bin is at or near capacity. Alternatively, and/or additionally, an embedded user interface located on the waste bin itself may provide a visual and/or audible indication that a waste bin is full, or a user interface on a web-enabled device (e.g., a smartphone, tablet computer, etc.) in communication with the waste container may provide a similar visual and/or audible indication that a waste bin 108 is full.

Other sensors of the sensor module 106 may determine from shape, weight, radar profile, and color, for example, that an identified object may be too contaminated to be properly recycled according to local regulations. For example, while a newspaper may typically be recyclable, a food or grease contamination on any surface thereof may not be recyclable. Thus, if the determination result in the newspaper being deposited into a landfall bin.

A processor module 109 may be connected to a classification database comprising a library 107. The library 107 and components of a system memory 127 may be additionally or alternatively remotely located via a wired or a wireless network in another embodiment. The system 100 may store, in a data set in computer-readable memory, information regarding the type of waste received. Further, the data set may associate the type of waste with an identifier associated with the discarded items. The processor system 109 may also retrieve the information regarding the type of waste in the identifier associated with the waste and output information and/or statistics to a user of the system on a display device or via an audio output, if the waste container is equipped with a speaker or screen of a display panel 113. Such information may be used in utilizing game mechanics to incentivize consuming items that lead to recyclable waste, educating material type in schools about what is recyclable and not, etc. For example, when two different waste containers are placed on two different floors in an office building, the processor may keep track of which floor discarded more recyclable waste, and award incentives, such as game points, to the floor that discarded more recyclable waste. The data may be used by municipalities and commercial entities to analyze waste streams.

Other data may include educational information 131 as described herein. The presentation module 112 may communicate information 131 to be used in some respects to educate users on proper disposal. The waste stream may be optimized to promote recycling and reduce landfill use. The presentation module 112 may provide insights on the effects of recyclable packaging and may suggest optimal collection routes for employees, as automatically determined by the processor system 109.

The display module 206 may include an embedded display that additionally provides, for example, instructions on proper disposal of waste, information on what is (or is not) considered recyclable waste, advertisements, etc. In one aspect, in the event that a discarded item is not recyclable due to contamination or other reasons, the display or user interface may provide an indication to the user as to why the waste was placed in a landfill waste bin as opposed to a recyclable waste bin. For example, if the user places a plastic bottle into the waste bin that is still filled with an impermissible amount of liquid, the display or user interface may provide visual and/or audible feedback to the user, explaining why the plastic bottle was not recyclable. Furthermore, the display or user interface may provide the user with one or more recommendations as to how to properly dispose of the waste in the future. Alternatively, and/or additionally, the display or user interface may not be located on the waste bin itself, but may instead be located on a web-enabled device (e.g., a smartphone, tablet computer, etc.) in communication with the waste container. Sensors may be trained to identify contamination of otherwise recyclable material, as described herein.

An identification/classification library 107 of the system 100 use the sensor input, along with machine learning to identify discarded objects with particularity. A sorting module 122 may physically direct discarded objects into appropriate bins 108.

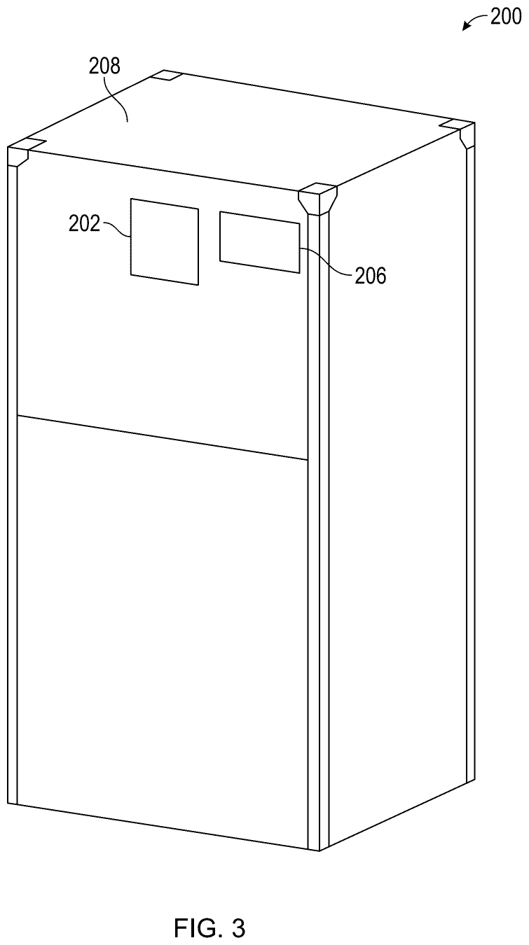

FIG. 3 is a perspective view of a discarded item container 200 that includes multiple openings 202, 204 for different types of items, as well as a panel to communicate data pertinent to the operation of the container (e.g., fullness, charge, or estimated fullness, another other data) according to various embodiments. The container 200 receives a items through the one or more openings 202, 204. The disposal openings 202, 204 may include identifiers for placing the waste item into the appropriate device identification space.

The openings 202, 204 may be disposed in various arrangements, such as one opening next to the other as shown in FIG. 3, one opening behind the other, one opening diagonal with respect to the other, etc. Each opening 202, 204 may be without a cover, may include a flap or a sliding door. While two openings 202, 204 are shown in FIG. 3, it is to be understood that waste container 200 may include more or fewer openings and/or flaps. In addition, other configurations are possible, such as a room or other locations with separate waste bins arranged near each other proximate one or more waste receiving openings, such as a garbage chute in a building, in which case it may be considered a waste receiving system rather than a single waste container.

The container 200 may additionally include a solar panel 208. The solar panel 208 may allow the container to be positioned in areas where an electrical grid is unavailable.

A display panel 206 may be controlled by a processor and transceiver that may communicates container information. The information displayed at the panel 206 may additionally be sent to one or more remote facilities via a communication network. In addition, the waste container 200 may include a transceiver that sends data to, and receives commands from, a remote processor via a communication network. The remote processor may be associated with a remote computer system such as a server, a desktop computer, a laptop computer, a mobile device, a personal digital assistant, etc.

By way of example, the communication network may include a data network, a wireless network, a telephony network, or any combination thereof. The data network may be any local area network (LAN), metropolitan area network (MAN), wide area network (WAN), a public data network (e.g., the Internet), short range wireless network (such as a Wi-Fi network), a packet-switched network (e.g., a proprietary cable or fiber-optic network and the like), or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium (e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad hoc network (MANET), and the like), or any combination thereof.

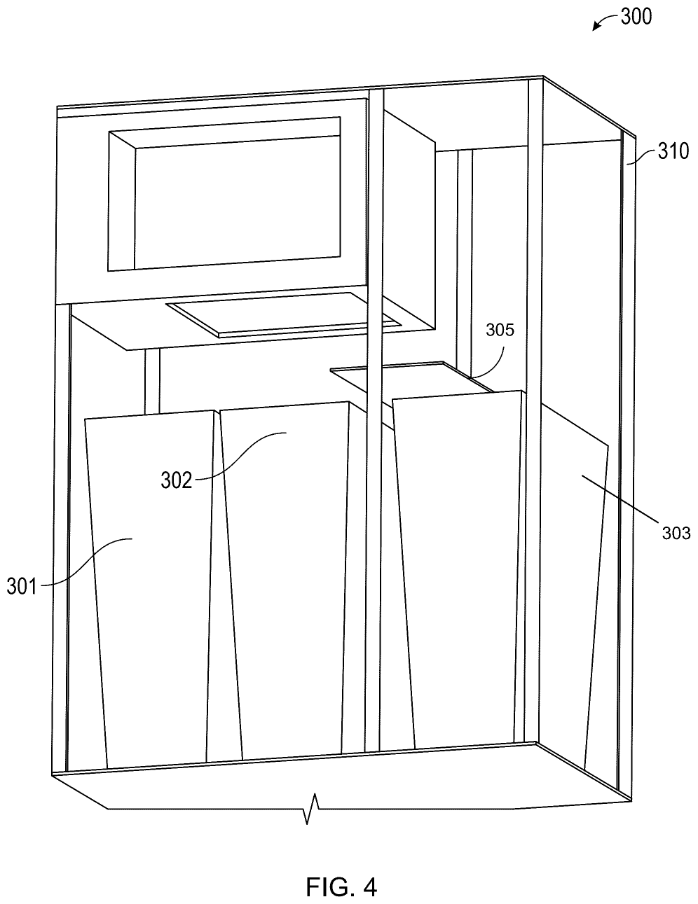

FIG. 4 is a perspective view of a container 300 without an exterior cover to show internal components that include a multiple waste bins 301-303.

The container 300 may include one or more tiltable sorting panels 305 that are disposed above the waste bins 301-303. The waste bins 301-303 may be designated for recyclables, landfill garbage, metal, compost, hazardous waste, etc. A discarded item, via one or more openings, may be directed by the one or more tiltable sorting panels 305 into one of the two or more waste bins 301-303 through the identification of the type of object placed within the container 300. A tiltable platform 305 may be tilted to one direction when the object placed inside the container 300 is identified as trash, or may be tilted to another direction when the object placed inside the container is identified as recyclable. The tilt direction may be managed by a control parameter that indicates into which waste bin 301-303 a particular type of object is to be directed when the platform performs the tilting operation. The tilt platform 305 may move from one position to another position as required to place an object in the desired waste bin 301-303. The frame 310 associated with the waste container 300 may be any kind of structural material, including plastic rods, aluminum bars, or other metals. The size of the waste container 300 and/or the number and/or size of waste bins 301-303 may be customizable based on local waste disposal regulations. For example, a municipality allowing mixed recycling (i.e., the mixing of most or all recyclable materials in one container or bin) may only necessitate two waste bins, i.e., one for recyclables and one for landfill waste. On the other hand, a municipality requiring sorted recycling (i.e., individual containers or bins for most or all recyclables) may necessitate more than two waste bins.

The container system 300 includes identification module (not shown) that may include various sensors that collect data that a processor module (not shown) may identify the discarded item prior to be sorted. Sensors may additionally be positioned to sense the contents (e.g., composition, fullness, and weight, among other measurable quantities) of the bins 301-303. The sensors may include, for example, inductive sensors, capacitive sensors, photoelectric sensors, load sensors, cameras, temperature sensors, infrared sensors, near-infrared sensors, odor sensors, spectral imaging sensors (such as spectrometers), audio sensors, capacitive sensors, fluorescence sensors, millimeter-wave radar sensors, or depth cameras such as a red/green/blue (RGB) depth cameras, etc. Where so configured, a sensor may detect if a door is open. For instance, certain or all operations may be temporarily halted when a door is determined to be open.

Information from the sensors may be communicated to the processor module for analysis and eventual communication to one or more display devices or audio outputs (speakers), to output information to a user as described herein.

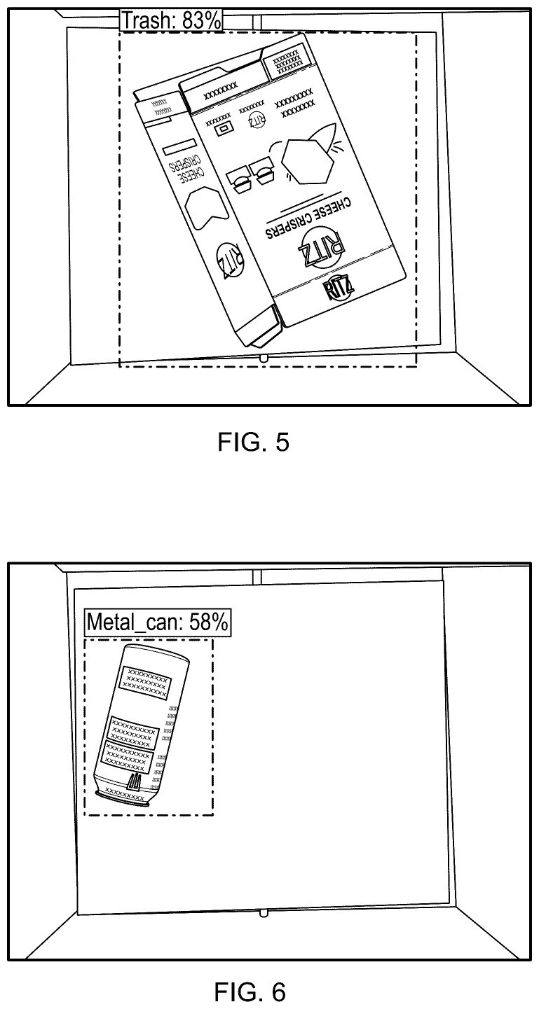

FIG. 5 presents a view of the identification by the processor module of an object placed upon the tiltable sorting platform through the opening in the front panel of the waste sorting and analysis apparatus. In a non-limiting example, the item placed within the waste sorting and analysis apparatus has been determined, through analysis of the item, as having a high probability of being a waste item. The system may then activate the tiltable platform (not shown) to place the item in the waste container.

FIG. 6 presents a view of the identification by the processor module of an object placed upon the tiltable sorting platform through the opening in the front panel of the waste sorting and analysis apparatus. In a non-limiting example, the item placed within the waste sorting and analysis apparatus has been determined, through analysis of the item, as having a high probability of being a recyclable item. The system may then activate the tiltable platform (not shown) to place the item in the recycling container.

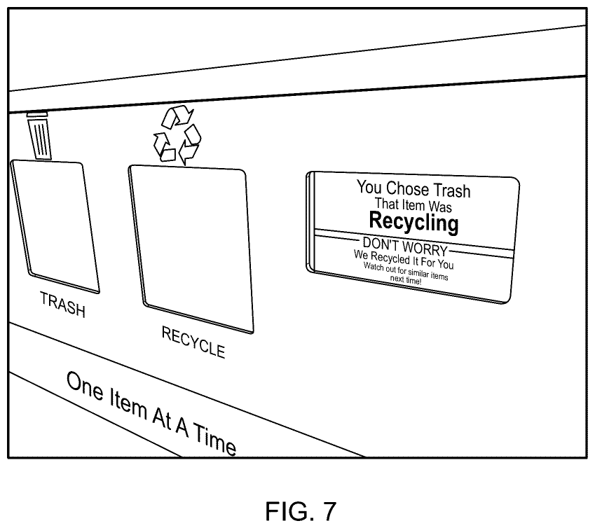

FIG. 7 is a view of an error message that may be displayed on a front panel display that communicates information to the user. In a non-limiting example, the front panel display provides a message indicating that the user has selected an incorrect item type that was placed within the waste container system. The front panel display may be configured to present multiple informational, error, and confirmation messages to a user of the waste container apparatus 100.

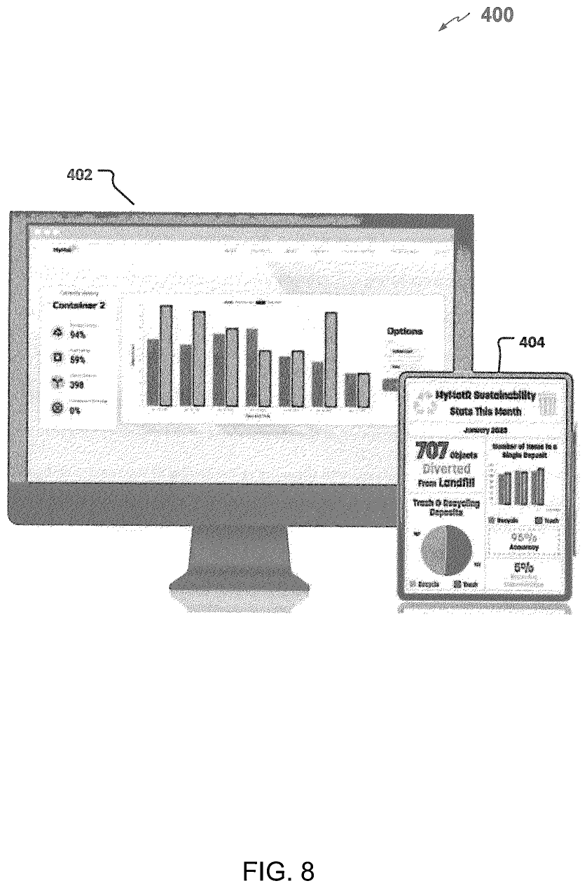

FIG. 8 is a system 400 that includes multiple electronic display devices 402, 404 configured to relate waste stream and container information to a user. Such information may include updates on how much has been recycled and diverted from landfills. Other information may relate to container battery life and waste bin capacity, as well as potential jams/clogs or other interruptions in operation. While the illustrative display of FIG. 8 is shown on a cellular phone and on an online website displayed by a desktop computer, or may be presented on a display screen of the unit.

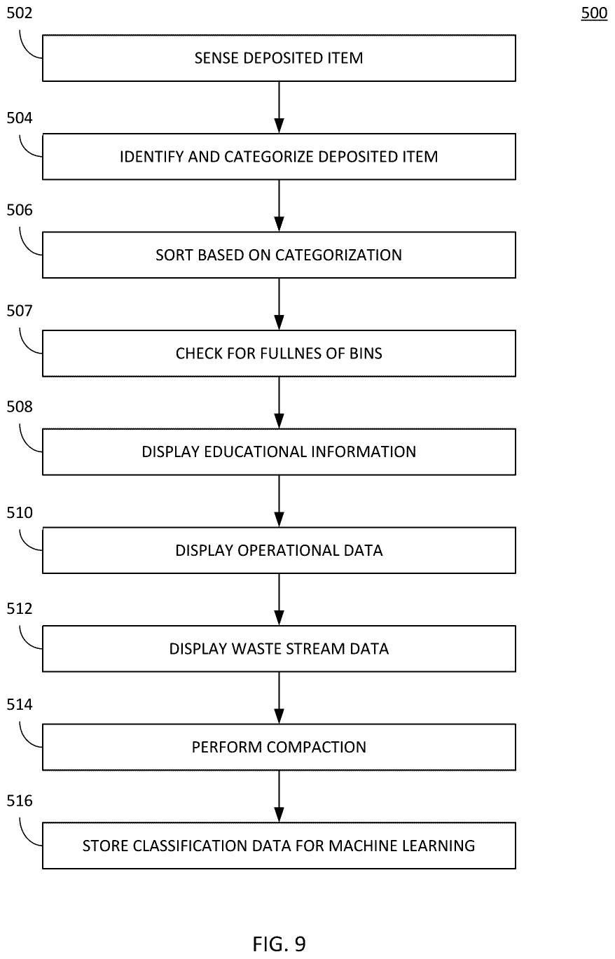

FIG. 9 is a flowchart of a method to automatically sort discarded items according to an embodiment. Any of a number of different sensors may detect at 502 that a discarded item has been received into a waste container system. For example, a motion detection sensor may detect motion of an item in an opening of the system, a door opening sensor may detect that someone has opened a door of the system to place waste into it, or a load sensor may detect that a weight has been received. Two or more sensors will capture data points that the system will use to determine the type of waste and which waste bin should receive the piece of waste. For example, a camera may capture a digital image of the piece of waste placed within the waste container. A load sensor may weigh the piece of waste. A metal detector circuit may include an inductance sensor and a capacitive sensor that detect whether the piece of waste is made of metal, and if so what type of metal. Alternatively, and/or additionally, one or more other sensors, such as temperature sensors, infrared sensors, an odor sensor, spectroscopy sensors, audio sensors, capacitive sensors, fluorescence sensors, millimeter-wave radar sensors, depth cameras, etc., may be used in lieu of, or in addition to, the sensors described herein.

At 504, the system may analyze data received by at least a first one of the sensors and compare that data to a data set of known waste material types to identify whether the waste is made of a recyclable or non-recyclable material. For example, if the first sensor is a camera the camera may capture a digital image of the discarded object and process the digital image to determine whether content of the digital image corresponds to one or more characteristics of a known recyclable object. The image processing may be performed using any now or hereafter known image processing techniques, including but not limited to edge detection, object recognition, feature extraction, and other techniques. The characteristics of known recyclable objects may be stored in a data set that is accessible to the processor. Examples of characteristics of known objects that the data set may store include a logo (e.g., a product trademark), text of a known product name, a shape, and/or a color scheme.

If the content of the digital image corresponds to one or more characteristics of a known recyclable object in the data set, the system will classify the piece of waste as being formed of a recyclable material and either deposit it into a recyclable waste bin or perform additional analysis as described herein.

Should the content of the digital image does not correspond to one or more characteristics of a known recyclable object, the system will classify the piece of waste as being formed of a non-recyclable material and direct it to a non-recyclable waste bin. Optionally, the system may analyze the sensed data to determine whether this material is compostable and if so direct the material to a compostable waste bin.

Should the content of the digital image correspond to one or more characteristics of a known recyclable object in the data set, the system will classify the piece of waste as being formed of a recyclable material and either deposit it into a recyclable waste bin at 506 or perform additional analysis as described herein. As another example, if one of the sensors in an inductance sensor (on its own or in combination with other sensors of a metal detector), the system may determine that the waste is formed of a recyclable material if the inductance sensor indicates that the piece of waste is metallic.

Rather than just one sensor, the system may analyze the image produced by the camera, the weight measurement produced by the load sensor, and the inductance measured by the inductance sensor in combination to determine the type of waste, using any suitable algorithms, or comparison of the sensed data to characteristics of material types as stored in a data set. If one of the sensors is a camera, the system may analyze the image produced by the camera, and the processor may use vision algorithms to produce a list of categories and a corresponding list of probabilities associated with the object. The processor may utilize a machine learning method such as, for example, Bayesian Classification, which may compare the image or other captured sensor data against a trained data set to determine the probability that the item in the image represents a particular, known item. For example, given an image, the vision algorithm may produce the list of categories (e.g., a bag, a sandwich, a soft drink can) and a corresponding list of probabilities. In this example, the list of probabilities indicates that the image is a magazine within a first probability, a plate with a second probability, and a pen with a third probability.

As part of the categorization process at 504 and prior to directing a recyclable material into a recyclable waste bin 506, the system may use additional sensed data to determine whether the waste meets a recyclability threshold. For example, if the classification step determined that the piece of waste is a food or beverage container, the recyclability threshold may be a requirement that the container contain no more than a threshold amount of liquid or other material. The system may then determine the weight of the object and determine whether the weight meets or exceeds a threshold beyond which recyclability is not possible. As another example, if the classification step determined that the piece of waste is a cardboard box, the system may use a sensor (such as a camera) to determine whether the box is a pizza box, and, if so, move the box to a non-recyclable waste bin based on a rule that pizza boxes are typically contaminated with food particles and thus expected to be non-recyclable.

The system also may take weight of the object into account when determining whether or not a piece of waste is recyclable. For example, the system may store a table of weights and corresponding pieces of waste in a memory. For example, the table may include information that a metal typically weighs in the range of 10 g-15 g and a plastic container typically weighs in the range of 15 g-20 g, etc. The weight categories may correspond to the categories produced by the vision algorithm, may be overlapping, or may be disjointed. Based on the weight of the piece of waste placed in the waste container, the processor may assign a probability to each category. The processor may assign the probability to a category in various ways. For example, if the weight falls into several categories, the processor may evenly distribute the probability among the several categories.

An implementation may also take inductance of the object into account when determining whether or not a particular piece of waste is recyclable or to determine the recyclability threshold. To do this, the processor may store a table of inductances and corresponding pieces of waste in the memory. For instance, the inductance for most materials that do not include metal varies from those that do. Thus, in some embodiments the recyclability threshold may be associated with a particular inductance level.

In the event that the processor is unable to positively identify that a piece of waste is a particular type of waste with a predetermined level of certainty, the system may automatically divert the waste to a bin designated for landfill disposal. For example, if, after assigning probabilities that a piece of waste is formed of a particular material based on the various sensor input described above, the processor still does not recognize the type of waste with at least certain percentage of certainty, the system may divert the waste to a landfill bin. In one programmed implementation, the processor may execute program code designating a default identification as something other than trash. Such may be case, for instance, with a three or four-way sorting configuration. Other implementations may have a default setting that classifies a discarded object as being trash.

The processor may cause a movable door to actuate and close or lock the opening to prevent the user from interfering with the processing of the piece of waste. The processor may determine using one or more sensors to determine a type of the waste and whether the waste is formed of a recyclable material or a non-recyclable material. The waste type may recyclable material or non-recyclable material. Non-recyclable materials may be subcategorized as landfill material, compost material, or other categories. If the material type is determined to be a recyclable material, the material type may further be categorized as plastic, paper, metal, or other recyclable material types. Furthermore, each material type category may have a subcategory. For instance, the material may be determined to be a recyclable material such as metal, plastic, paper, cardboard, cloth, or glass. In response, the processor causes an actuated sorting compartment to deposit the waste into an appropriate waste bin, such as by activating the motor so that the actuated sorting compartment releases the piece of waste into the recyclable waste bin. Still other classification processes may include determining at 506 that a lingering hand used to deposit an object is not miscategorized as being part of the discarded object.

At 507, the system may verify that the identified object, if potentially recyclable, is not contaminated, as described herein.

Educational information may be displayed at 508 to a user who has deposited an object, and container operational data may be displayed and otherwise communicated to users at 510. Other presented data presented at 512 may relate to the garbage collection/waste stream.

Where so configured, the system may perform compaction on one or more waste bins at 514. The compaction may be initiated automatically or in response to user input. Data, including characterization data, may be uploaded and used for machine learning purposes at 516 to more efficiently identify and analyze discarded objects during future operations.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The processing systems described herein may comprise any machine capable of executing a set of instructions (sequential or otherwise) that specify actions to be taken by that machine. The machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that he disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the disclosure describes certain embodiments and the best mode contemplated, no matter how detailed the above appears in text, the embodiments may be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the claims.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c. As used herein, “based on” is intended to be interpreted in the inclusive sense, unless otherwise explicitly indicated. For example, “based on” may be used interchangeably with “based at least in part on,” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also may be implemented in combination in a single implementation. Conversely, various features that are described in the context of a single implementation also may be implemented in multiple implementations separately or in any suitable sub combination. As such, although features may be described above as acting in particular combinations, and even initially claimed as such, one or more features from a claimed combination may in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart, or flow diagram. However, other operations that are not depicted may be incorporated in the example processes that are schematically illustrated. For example, one or more additional operations may be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

What is claimed is:

1. An apparatus comprising:
a container housing including at least one opening in the enclosure;
a camera configured to capture a visual input relating to a deposited object placed into the at least one opening;
a light source configured to illuminate the deposited object;
a sorting plate configured to divert the deposited object into one of a plurality of containers;
a motor configured to move the sorting platform; and
a processor system configured to:
receive the visual input from the camera;
classify the deposited object based on the visual input; and
cause the motor to move the sorting place to divert the deposited object to the one of the plurality of containers based on the classification.

2. The apparatus of claim 1, wherein the processor system is further configured to identify operation of the apparatus through the insertion of the hand of a user into the apparatus.

3. The apparatus of claim 1, wherein the processor system is configured to initiate an alert to the user to remove their hand.

4. The apparatus of claim 1, further comprising a sensor positioned proximate to one of the plurality of containers to sense at least one of a fullness level and a weight.

5. The apparatus of claim 1, further comprising providing informational, error, and confirmational messages to a user of the apparatus.

6. The apparatus of claim 1, wherein the processor system initiates updates and operation of the system through communication with a mobile device.

7. The apparatus of claim 1, further comprising a memory configured stored information relating to at least one of: images of every discarded, timestamp data, a number of items diverted from a landfill, a confidence of image identification, a processing cycle time of a device contamination percentage of recyclables, a fullness of the plurality of containers, a wireless connection, a power level, and a waste stream composition.

8. The apparatus of claim 1, wherein the at least one LED includes a plurality of multicolored LEDs.

9. The apparatus of claim 1, wherein classifying the discarded object includes assigning a confidence level to the classification where such confidence level information is used to improve identification of discarded objects placed within said apparatus.

10. The apparatus of claim 1, wherein the processor system is further configured to classify the deposited item as being at least one of: metal, composite, plastic, glass, paper, ceramic, and compost.

11. The apparatus of claim 1, further comprising a solar module configured to provide power to a power module configured to power the processor system.

12. The apparatus of claim 1, wherein the container housing is weatherproof.

13. The apparatus of claim 1, further comprising a limit switch configured to detect positional data relating to the at least one opening.

14. The apparatus of claim 13, wherein the processor system is further configured to initiate an alert when the at least one opening is open longer than a preset threshold of time.

15. The apparatus of claim 1, further comprising a code scanner configured to identify a bar code of the deposited item.

16. The apparatus of claim 1, wherein the processor system is further configured to initiate an alert when a clog is detected.

17. The apparatus of claim 1, wherein the plurality of containers includes at least three containers.

18. The apparatus of claim 1, wherein the plurality of containers includes at least four containers.

19. The apparatus of claim 1, wherein the plurality of containers are differently sized.

20. The apparatus of claim 1, wherein the processor system includes self-learning algorithms.
